(19) United States
(12) Patent Application Publication
(10) Pub. No.: US 2026/0228754 A1
(43) Pub. Date: Aug. 6, 2026

(54) Information Management of Product Manufacture

(71) Applicant: Siemens Aktiengesellschaft, München (DE)

(72) Inventors: He Peng Jia, BEIJING (CN); Lin Qi, BEIJING (CN)

(73) Assignee: Siemens Aktiengesellschaft, München (DE)

(21) Appl. No.: 18/868,995

(22) PCT Filed: May 27, 2022
(86) PCT No.: PCT/CN2022/095780

§ 371 Date: Nov. 25, 2024

(51) Int. Cl. G06Q 30/018; H04L 9/30; H04L 9/32

(52) U.S. Cl. CPC G06Q 30/018; H04L 9/30; H04L 9/3236

(57) ABSTRACT

Various embodiments of the teachings herein include a method for information management of product manufacture. An example method includes: storing a public key for verifying average carbon emission value of a batch of products in a first blockchain; storing a hash value of a carbon emission value of each product of the batch of products in a second blockchain; and determining a difference value between the carbon emission value of a particular product and an average carbon emission value of the batch of products and comparing the difference value to a threshold using product manufacture information to verify the carbon emission value of each product of the batch of products.

### CROSS-REFERENCE TO RELATED APPLICATIONS

This application is a U.S. National Stage Application of International Application No. PCT/CN2022/095780 filed May 27, 2022, which designates the United States of America, the contents of which are hereby incorporated by reference in their entirety.

### TECHNICAL FIELD

The present disclosure relates to blockchain technology. Various embodiments of the teachings herein include methods, apparatus, and devices for information management of product manufacture (for example, product carbon footprint).

### BACKGROUND

Product Carbon Footprint (PCF) is the total greenhouse gas emissions caused by a product, expressed as carbon dioxide equivalent. For a product, this may include analysis of the various life cycle stages from raw material extraction and processing, manufacture, distribution, use phase, and end of life treatment. Many companies now use this approach to gain a better understanding of carbon emissions through their supply chains and to identify efficiency opportunities.

PCF may be calculated by estimating CO₂ emissions which may include other greenhouse gas emissions such as nitrous oxide and or methane. To make the estimation more complete, in some cases the calculation may also involve additional impacts like the condensation trails from aircrafts' engines. The final expression is then the single number in terms of carbon dioxide equivalent (CO₂ₑ) which represents the sum of all impacts expressed in a single value.

This may include factory emissions and supplier emissions. Factory emission includes direct emissions, such as combustion of fossil fuels, emissions from chemical and physical processes etc.; and indirect emissions, such as external providers of electricity, heat, cooling or steam. Supplier emissions include emissions in the upstream supply chains.

In traditional information mode, manual operations are involved when the original data are collected and transmitted. Therefore, maloperations, malicious tampering and illegal manipulations are inevitable. Even if human factors are ignored, there are also other security problems.

To manage the PCF value accurately and reliably, a system may include: CIA (Confidentiality, Integrity, Availability), data authenticity, and identity privacy. Integrity means there is no data tampering. Data authenticity means data is accurate. Identity privacy means protection of the supplier's identity, for example, representing the material emission without revealing the suppliers. Confidentiality means protecting emission data, so only selected parties can see the real data.

There are known solutions using decentralized identity (DID) blockchain and verifiable credentials (VC) to manage the PCF data. In these, the DID blockchain is mainly used for VC verification. The PCF data will not be committed on the blockchain.

There are solutions using standard blockchain, e.g., Fabric, to support the data integrity and traceability in micro level, e.g., an individual product. In these, the blockchain is used to store PCF information. The PCF or its hash will be committed on the blockchain.

### SUMMARY

The teachings of the present disclosure address these objectives. Various embodiments of these teachings may include methods for information management of product manufacture, apparatus for information management of product manufacture, computer devices for information management of product manufacture, and a computer program. Features of the various embodiments may be combined.

For example, some embodiments of the teachings herein include a method for information management of product manufacture is presented. An example method comprises: storing, in a first blockchain, a public key for verifying average carbon emission value of a batch of products; storing, in a second blockchain, hash value of a carbon emission value of each product of the batch of products; and determining a difference value between a carbon emission value of the product and average carbon emission value of the batch of products being within a threshold by using product manufacture information to verify the carbon emission value of each product of the batch of products.

In some embodiments, the public key for verifying average carbon emission value of a batch of products is stored in the first blockchain.

In some embodiments, computing the threshold is based on a serial number or date of manufacture of the product.

In some embodiments, the method includes creating a verifiable presentation of the batch of products associated with carbon emission value by wrapping a verifiable credential of the batch of products provided by the certifier to protect identity privacy of the batch of products; and verifying the verifiable presentation by the public key stored in the first blockchain.

In some embodiments, the first blockchain is decentralized identity (DID) blockchain and the second block chain is standard blockchain.

As another example, some embodiments include an apparatus for information management of product manufacture. An example apparatus includes: first storage module for storing, in a first blockchain, a public key for verifying average carbon emission value of a batch of products; second storage module for storing, in a second blockchain, hash value of a carbon emission value of each product of the batch of products; and determination module for determining a difference value between a carbon emission value of the product and average carbon emission value of the batch of products being within a threshold by using product manufacture information to verify the carbon emission value of each product of the batch of products.

As another example, some embodiments include a computer device for information management of product manufacture, comprising a memory and a processor, wherein an application executable by the processor is stored in the memory for causing the processor to perform one or more of the methods described herein.

As another example, some embodiments include a computer-readable storage medium storing computer-readable instructions for performing one or more of the methods described herein.

As another example, some embodiments include a computer program product stored on a tangible computer-readable medium and includes computer-readable instructions that, when executed, cause at least one processor to perform one or more of the methods described herein.

### BRIEF DESCRIPTION OF THE DRAWINGS

The above-mentioned attributes and other features and advantages of the teachings of the present disclosure and the manner of attaining them will become more apparent and the present technique itself will be better understood by reference to the following description of embodiments of the present technique taken in conjunction with the accompanying drawings, wherein:

FIG. 1 is a flow chart depicting an example method for information management of product manufacture incorporating teachings of the present disclosure;

FIG. 2 is a drawing depicting an example computer apparatus for information management of product manufacture incorporating teachings of the present disclosure;

FIG. 3 is a drawing depicting an example computer device for information management of product manufacture incorporating teachings of the present disclosure.

REFERENCE NUMBERS

| S101-S104 | Steps |
|---|---|
| 200 | apparatus |
| 201 | first storage module |
| 202 | second storage module |
| 203 | determination module |
| 300 | computer device |
| 302 | memory |
| 304 | processor |

### DETAILED DESCRIPTION

Hereinafter, above-mentioned and other features of the present techniques are described in detail. Various embodiments are described with reference to the drawings, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the scope of this disclosure. It may be evident that some embodiments may be practiced without these specific details.

In order to make the technical solutions and advantages of the teachings herein clearer, they are further described in detail below with reference to the accompanying drawings and embodiments. The specific embodiments described herein are only used to illustrate the teachings and are not configured to limit the protective scope of the disclosure.

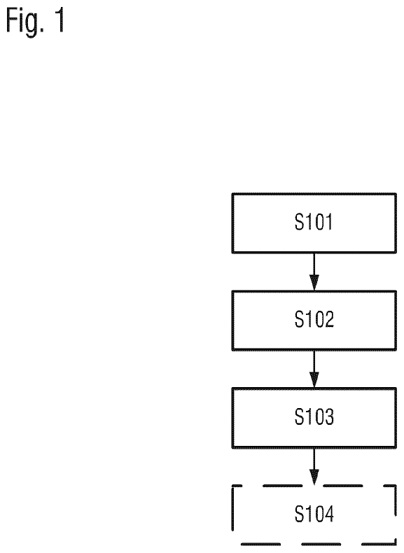

FIG. 1 is a flow chart depicting an example method for information management of product manufacture incorporating teachings of the present disclosure.

S101 includes storing, in a first blockchain, a public key for verifying average carbon emission value of a batch of products. Here, a batch of products can be 1000 products whose serial number from 1 to 1000 made in May.

S102 includes storing, in a second blockchain, a hash value of a carbon emission value of each product of the batch of products. Here, it records each product's carbon emission value for this batch. The gas can be carbon or CO₂.

S103 includes determining a difference value between a carbon emission value of the product and average carbon emission value of the batch of products being within a threshold by using product manufacture information to verify the carbon emission value of each product of the batch of products. Here, the product manufacture information can be a serial number or date of manufacture. The threshold, for example, can be 2.

In summary, the information management of product manufacture about gas emission is more accurate and reliable compared to prior solutions.

In some embodiments, the first blockchain is decentralized identity (DID) blockchain; and the second block chain is standard blockchain. DID blockchain is Decentralized Identity Blockchain. Standard blockchain is Hyperledger-Fabric blockchain (also called as Fabric blockchain). The Fabric blockchain stores and provides factory materials' PCF hashes.

Computing the threshold may include using a serial number or date of manufacture to get the threshold. In some embodiments, the method includes computing the threshold based on a serial number or date of manufacture of the product. For example, a serial number can be 0001-1000, and date of manufacture of the product can be May.

In an example, the normal product's carbon emission value is 10, and abnormal product's carbon emission value is 8. We can compute the average value of the production is 10 by summing up carbon emission value of each product whose serial number is within 0001-1000 and made in May. Then, we can get that the difference value is 0 for normal product's carbon emission value, and the difference value is 2 for abnormal product's carbon emission value. So, we set the threshold as 2.

In some embodiments, S104 includes creating a verifiable presentation of the batch of products associated with carbon emission value by wrapping a verifiable credential of the batch of products provided by the certifier to protect identity privacy of the batch of products; and verifying the verifiable presentation by the public key stored in the first blockchain. We can make sure the carbon emission value of products is more reliable and protect identity privacy.

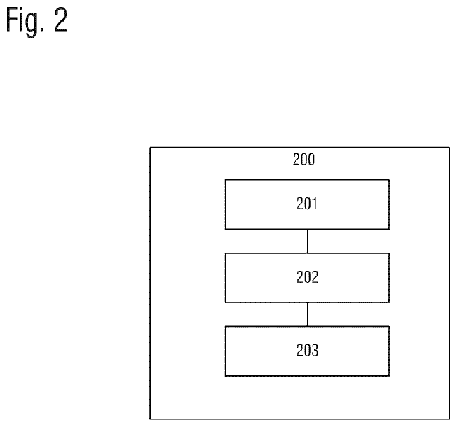

FIG. 2 is a drawing depicting an example apparatus 200 for information management of product manufacture incorporating teachings of the present disclosure, including: a first storage module 201 for storing, in a first blockchain, a public key for verifying average carbon emission value of a batch of products; a second storage module 202 for storing, in a second blockchain, hash value of a carbon emission value of each product of the batch of products; and a determination module 203 for determining a difference value between a carbon emission value of the product and average carbon emission value of the batch of products being within a threshold by using product manufacture information to verify the carbon emission value of each product of the batch of products.

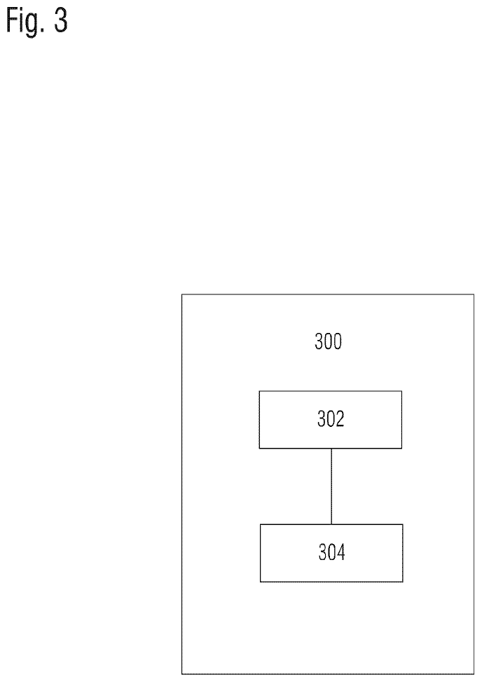

FIG. 3 is a drawing depicting an example computer device 300 incorporating teachings of the present disclosure. The computer device 300 comprises a memory 302 and a processor 304, wherein an application executable by the processor is stored in the memory 302 for causing the processor 304 to perform one or more of the methods for information management of product manufacture described herein.

It should be noted that not all the steps and modules in the above-mentioned processes and structure diagrams are required, and certain steps or modules may be omitted according to actual needs. The execution order of each step is not fixed and can be adjusted as needed. The division of each module is only functional division for ease of description. In actual implementation, one module can be divided into multiple modules, the functions of multiple modules can also be realized by one module, and these modules can be in the same device and can also be in different devices.

The hardware modules in various embodiments may be implemented mechanically or electronically. For example, a hardware module may comprise a specially designed permanent circuit or logic device (such as a dedicated processor, like an FPGA or ASIC) for performing certain operations. A hardware module may also comprise a programmable logic device or circuit temporarily configured by software (for example, comprising a general-purpose processor or other programmable processors) for performing certain operations. Whether to adopt a mechanical method, or a dedicated permanent circuit, or a temporarily configured circuit (for example, configured by software) for the hardware module can be decided based on cost and time considerations.

Some embodiments of the teachings herein include a machine-readable storage medium storing instructions for causing a machine to perform one or more of the methods as described herein. Specifically, a system or device equipped with a storage medium may store a software program code for realizing the functions of any of the above embodiments is stored on the storage medium, and a computer (or CPU or MPU) of the system or device is made to read out and execute the program code stored in the storage medium. In addition, some or all of the actual operations may be performed by an operating system or the like operating on a computer based on instructions of the program code. The program code read out from the storage medium may also be written into a memory arranged in an expansion board inserted into the computer or written into a memory arranged in an expansion unit connected to the computer, and then some or all of the actual operations are executed by a CPU or the like installed on the expansion board or the expansion unit based on the instructions of the program code, so as to achieve the functions of any of the above-described embodiments.

The storage medium for providing the program code can be implemented as floppy disk, hard disk, magneto-optical disk, optical disk (such as CD-ROM, CD-R, CD-RW, DVD-ROM, DVD-RAM, DVD-RW, DVD+RW), magnetic tape, non-volatile memory card and ROM. Alternatively, the program code may be downloaded from a server computer or cloud through a communication network.

The above description includes example embodiments of the teachings herein but do not limit the protection scope of the disclosure. Any modification, equivalent replacement and improvement made within the spirit and principle of the disclosure shall fall within the protection scope thereof.

It should be noted that not all the steps and modules in the above-mentioned processes and system structure diagrams are required, and certain steps or modules may be omitted according to actual needs. The execution order of each step is not fixed and can be adjusted as needed. The system structures described in the foregoing embodiments may be physical structures or logical structures, that is, some modules may be implemented by the same physical entity, or some modules may be implemented by multiple physical entities or may be implemented by certain components in multiple independent devices together.

In the above embodiments, a hardware unit may be implemented mechanically or electrically. For example, a hardware unit may comprise a permanent dedicated circuit or logic (such as a dedicated processor, like an FPGA or ASIC) for performing corresponding operations. A hardware unit may also comprise a programmable logic or circuit (such as a general-purpose processor or other programmable processors) which can be temporarily configured by software to perform corresponding operations. The specific implementation method (a mechanical method, or a dedicated permanent circuit, or a temporarily configured circuit) can be decided based on cost and time considerations.

The teachings have been illustrated and described in detail with reference to the accompanying drawings and example embodiments. However, the disclosure is not limited to these disclosed embodiments, and based on the above embodiments, those skilled in the art can understand that the code auditing means in the above different embodiments can be combined to obtain more embodiments, and these embodiments also fall within the protection scope of the present disclosure.

What is claimed is:

1. A method for information management of product manufacture, the method comprising:
storing a public key for verifying average carbon emission value of a batch of products in a first blockchain;
storing a hash value of a carbon emission value of each product of the batch of products in a second blockchain; and
determining a difference value between the carbon emission value of a particular product and an average carbon emission value of the batch of products and comparing the difference value to a threshold using product manufacture information to verify the carbon emission value of each product of the batch of products.

2. The method according to claim 1, further comprising storing a respective public key for verifying average carbon emission value of a batch of products in the first blockchain.

3. The method according to claim 1, further comprising computing the threshold using a serial number or date of manufacture of the product.

4. The method according to claim 1, further comprising:
creating a verifiable presentation of the batch of products associated with carbon emission value by wrapping a verifiable credential of the batch of products provided by the certifier to protect identity privacy of the batch of products; and
verifying the verifiable presentation by the public key stored in the first blockchain.

5. The method according to claim 1, wherein:
the first blockchain comprises a decentralized identity (DID) blockchain; and
the second block chain comprises a standard blockchain.

6. An apparatus for information management of product manufacture, the apparatus comprising:
a first storage module for storing a public key for verifying average carbon emission value of a batch of products in a first blockchain;
a second storage module for storing a hash value of a carbon emission value of each product of the batch of products in a second blockchain; and
a determination module for determining a difference value between a carbon emission value of the product and average carbon emission value of the batch of products and comparing the difference value to a threshold using product manufacture information to verify the carbon emission value of each product of the batch of products.

7. The apparatus according to the claim 6, the apparatus comprising further comprising
a module for storing the public key for verifying average carbon emission value of a batch of products in the first blockchain.

8. The apparatus according to claim 6, further comprising
a module for computing the threshold based on a serial number or date of manufacture of the product.

9. The apparatus according to claim 6, further comprising:
a creation module for creating a verifiable presentation of the batch of products associated with carbon emission value by wrapping a verifiable credential of the batch of products provided by the certifier to protect identity privacy of the batch of products; and
a verification module for verifying the verifiable presentation by the public key stored in the first blockchain.

10-12. (canceled)
